(19) United States
(12) Patent Application Publication
(10) Pub. No.: US 2026/0316951 A1
(43) Pub. Date: Oct. 15, 2026

(54) FUEL CONTROL SYSTEM

(71) Applicant: Safran Aircraft Engines, PARIS (FR)

(72) Inventors: Huguette DE WERGIFOSSE, MOISSY-CRAMAYEL (FR); Morgan LONGE, MOISSY-CRAMAYEL (FR)

(73) Assignee: Safran Aircraft Engines, PARIS (FR)

(21) Appl. No.: 19/490,285

(22) PCT Filed: Jun. 5, 2024
(86) PCT No.: PCT/FR2024/050721

§ 371 Date: Dec. 4, 2025

(30) Foreign Application Priority Data
Jun. 5, 2023 (FR) FR2305615

(51) Int. Cl. B64D 37/34; B64D 27/14; F02C 7/224

(52) U.S. Cl. CPC B64D 37/34; B64D 27/14; F02C 7/224

(57) ABSTRACT

The present invention relates to a fuel control system (4) for an aircraft engine (2), the system (4) comprising:—a pump (411);—a heat exchanger (413);—a recirculation circuit (42); and—a control device (43).

### TECHNICAL FIELD

This disclosure relates to the field of aeronautics. More specifically, this disclosure relates to fuel control within an aircraft engine.

### PRIOR ART

Some components of an aircraft engine are cooled by means of a heat transfer fluid. The heat transfer fluid can be any fluid circulating within the engine to cool or lubricate some engine parts, such as lubricating oil or a cooling fluid, for example, a cooling fluid for an electric machine. The heat thus absorbed by the heat transfer fluid is transferred to the fuel sent to the combustion chamber, typically via a heat exchanger arranged within the fuel control system.

The ability of the fuel to cool the heat transfer fluid depends on the temperature and flowrate of the fuel circulating within the heat exchanger.

It is therefore necessary to reduce the temperature of the fuel circulating within the heat exchanger, while simultaneously increasing its flowrate, regardless of engine speed, to effectively cool the engine components. More specifically, it is necessary to reduce the fuel temperature when the engine is operating at a speed where the fuel flowrate is too low, thus limiting heat exchange, for example, during idle flight.

Moreover, the Applicant is constantly working to reduce the climate impact of aircraft (minimizing greenhouse gas emissions, reducing the environmental footprint of aircraft operation), which involves improving the efficiency of electrical technologies within engines, in particular hybrid ones.

Ensuring the thermal and energy efficiency of cooling circuits within hybrid engines is crucial. The need to optimize heat exchange in the cooling fluids is particularly evident in aircraft engines comprising at least one electric assist machine, typically electrically hybridized turbofans, because cooling the electric assist machine further heats the cooling fluid, which then absorbs more heat.

### GENERAL DISCLOSURE

One purpose of this disclosure is to improve the heat absorption capabilities of a fuel control system for an aircraft engine, so as to increase the ability of the fuel to cool the heat transfer fluid.

To this end, a fuel control system for aircraft engines is proposed, according to one aspect of this disclosure, the system comprising:
a pump comprising an inlet port and a discharge port, the inlet port being intended to be connected to a fuel source, the discharge port being intended to be connected to a combustion chamber of the engine to supply the combustion chamber with fuel;
a heat exchanger comprising a primary circuit and a secondary circuit, the primary circuit of the heat exchanger having an inlet intended to be connected to the fuel source and an outlet connected to the pump inlet port, the secondary circuit of the heat exchanger being intended to be connected to a heat transfer fluid circuit of the engine, the heat exchanger being configured to provide heat transfer between fuel circulating in the primary circuit of the heat exchanger and heat transfer fluid circulating in the secondary circuit of the heat exchanger;
a recirculation circuit arranged to draw fuel discharged through the discharge port of the pump and reinject the drawn fuel into the primary circuit of the heat exchanger, the recirculation circuit comprising a bypass-valve configured to modulate the flowrate of fuel circulating within the recirculation circuit; and
a control device configured to control the bypass-valve based on a temperature of the heat transfer fluid circulating in the secondary circuit of the heat exchanger and/or a fuel flowrate at the inlet of the primary circuit of the heat exchanger, so as to increase the heat transfer between the fuel circulating in the primary circuit of the heat exchanger and the heat transfer fluid circulating in the secondary circuit of the heat exchanger.

### Advantageously, but optionally:

the control device is configured to control the bypass-valve based on a pressure difference across the terminals of the bypass-valve;

### the Pump Is of a Volumetric Type;

the pump has a variable displacement, the system further comprising a member for controlling the displacement of the pump;
the system further comprises a device for controlling a drive speed of the pump;
the bypass-valve is further configured to increase the flowrate of fuel circulating within the recirculation circuit in the event of failure of the control member and/or the control device;
the system further comprises an additional heat exchanger comprising a primary circuit and a secondary circuit, the secondary circuit of the additional heat exchanger being intended to be connected to an additional circuit of another heat transfer fluid of the engine, the additional heat exchanger being configured to ensure heat transfer between fuel circulating in the primary circuit of the additional heat exchanger and the other heat transfer fluid circulating in the secondary circuit of the additional heat exchanger;
the primary circuit of the additional heat exchanger has an inlet intended to be connected to the fuel source and an outlet connected to the inlet port of the pump;
the primary circuit of the additional heat exchanger has an inlet connected to the pump discharge port and an outlet intended to be connected to the combustion chamber of the engine.

According to another aspect of this disclosure, provision is made of an aircraft engine comprising:
a system as previously described;
a heat transfer fluid circuit connected to the secondary circuit of the heat exchanger of the system.

Advantageously, but Optionally:
the Engine Comprises:
   the system as previously described, wherein the system further comprises an additional heat exchanger comprising a primary circuit and a secondary circuit, the secondary circuit of the additional heat exchanger being intended to be connected to an additional circuit of another heat transfer fluid of the engine, the additional heat exchanger being configured to provide heat transfer between fuel circulating in the primary circuit of the additional heat exchanger and the other heat transfer fluid circulating in the secondary circuit of the additional heat exchanger; and
   an additional circuit of another heat transfer fluid connected to the secondary circuit of the additional heat exchanger of the system;
the heat transfer fluid is lubricating oil or a cooling fluid for an electric machine;
the other heat transfer fluid is lubricating oil or a cooling fluid for an electric machine.

According to another aspect of this disclosure, provision is made of an aircraft comprising an airframe and an engine, in which the engine is fixed to the airframe.

According to another aspect of this disclosure, provision is made of a method for controlling fuel for aircraft engines, the method comprising:
drawing a part of fuel discharged through a discharge port of a pump in a fuel control system of an engine, the discharge port being connected to a combustion chamber of the engine to supply it with fuel;
injecting the drawn fuel into a primary circuit of a heat exchanger of the system, the heat exchanger comprising the primary circuit and a secondary circuit, the primary circuit of the heat exchanger having an inlet connected to a fuel source of the system and an outlet connected to an inlet port of the pump, the secondary circuit of the heat exchanger being connected to a heat transfer fluid circuit of the engine, the heat exchanger being configured to provide heat transfer between fuel circulating in the primary circuit of the heat exchanger and heat transfer fluid circulating in the secondary circuit of the heat exchanger; and -modulating the fuel flowrate injected into the primary circuit of the heat exchanger so as to increase the heat transfer between the fuel circulating in the primary circuit of the heat exchanger and the heat transfer fluid circulating in the secondary circuit of the heat exchanger.

Advantageously, but optionally, the method is implemented by the system as previously described.

### DESCRIPTION OF THE FIGURES

Other features, purposes, and advantages will become apparent from the following description, which is purely illustrative and not exhaustive, and should be read in conjunction with the appended drawings on which:

FIG. 1 schematically illustrates an aircraft.

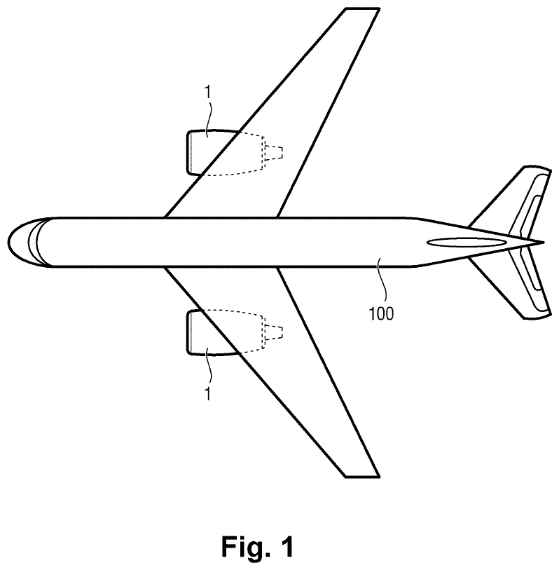

FIG. 2 illustrates a schematic cross-sectional view of an aircraft propulsion unit.

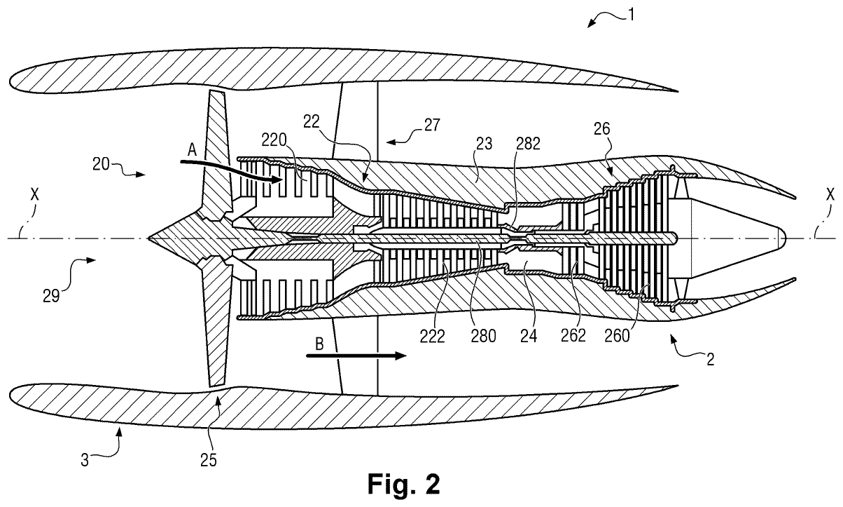

FIG. 3 schematically illustrates a fuel control system.

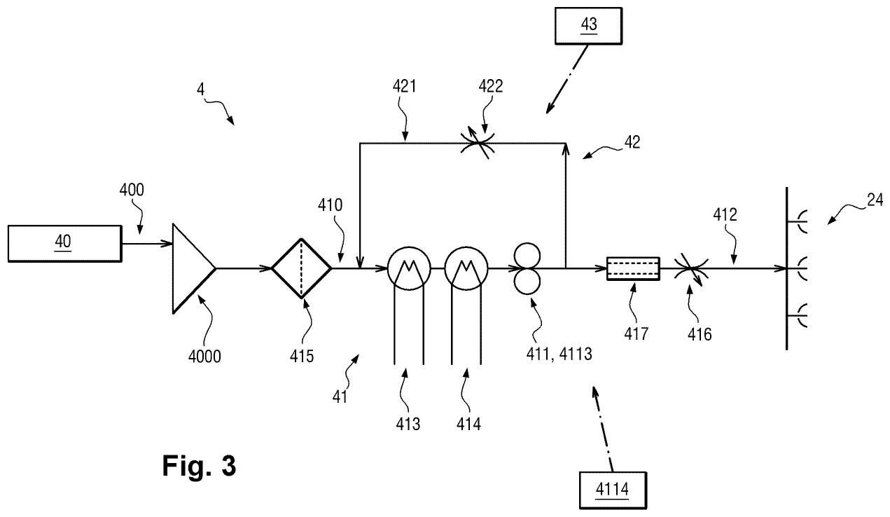

FIG. 4 schematically illustrates part of a fuel control system.

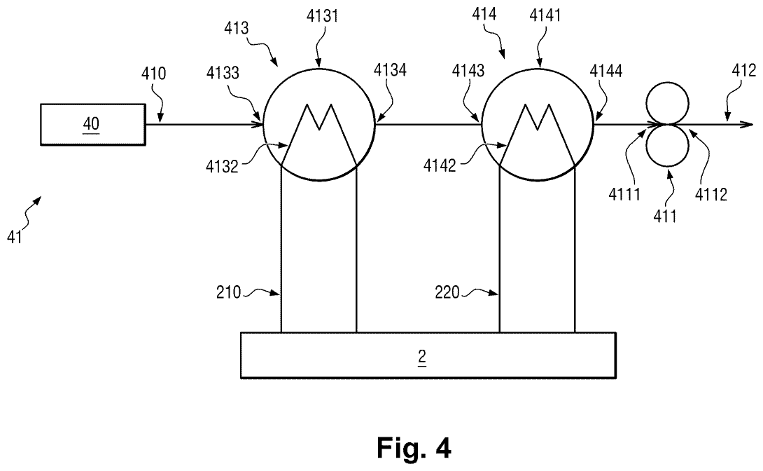

FIG. 5 schematically illustrates part of a fuel control system according to another alternative.

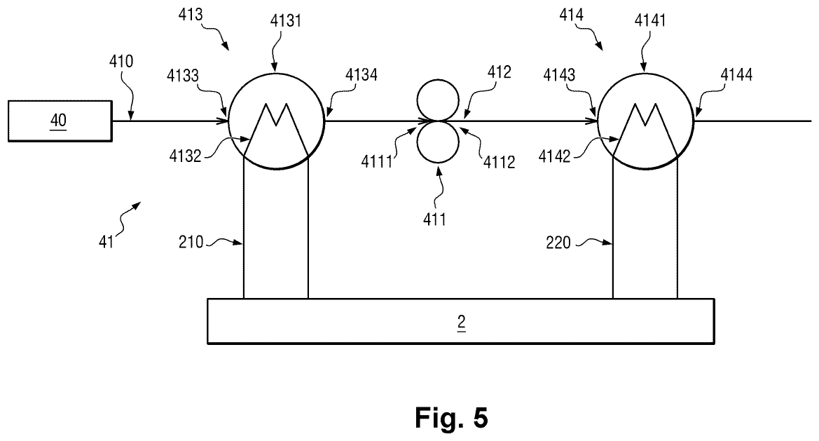

FIG. 6 is a flowchart illustrating a fuel control method for an aircraft engine.

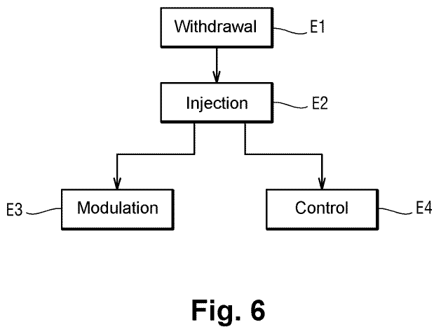

Across all figures, similar elements bear identical references.

### DETAILED DESCRIPTION

### Aircraft

An aircraft 100 is an apparatus configured to lift off and travel through the air, and can, for example, be a civil or military airplane, or even a helicopter. An aircraft 100 comprises an airframe which, in the case of an airplane, consists of a fuselage, a wing structure comprising two wings, tail assembly, flight control surfaces, and landing gear.

### Propulsion Unit

A propulsion unit 1 comprises an engine 2 (or turbomachine) and a nacelle 3, and has a main direction extending along a longitudinal axis X-X. The propulsion unit 1 is configured to be fixed to the airframe of the aircraft 100, for example under its wings in the case of an airplane, by means of a pylon (or mast). The propulsion unit 1 can also be mounted on the wing of the airplane or at the rear of its fuselage or even be integrated into its fuselage.

The engine 2 may be a ducted two-spool, twin-flow, direct-drive turbofan, as described below, but may also have a different number of spools and/or flows, and/or be another type of turbofan, such as a geared turbofan or a turboprop, with or without afterburner, ducted or unducted.

Unless otherwise specified, the terms “upstream” and “downstream” refer to the overall direction of airflow through the propulsion unit 1 in operation. Similarly, an axial direction corresponds to the direction of the longitudinal axis X-X, and a radial direction is a direction perpendicular to the longitudinal axis X-X and intersecting the longitudinal axis X-X. Moreover, an axial plane is a plane containing the longitudinal axis X-X, and a radial plane is a plane perpendicular to the longitudinal axis X-X. A circumference extends as a circle lying on a radial plane and whose center lies on the longitudinal axis X-X. A tangential or circumferential direction is a direction tangent to a circumference: it is perpendicular to the longitudinal axis X-X but does not pass through the longitudinal axis X-X. Finally, the adjectives “interior” (or “internal”) and “exterior” (or “external”) are used with reference to a radial direction so that the inner part of an element is, following a radial direction, closer to the longitudinal axis X-X than the outer part of the same element.

The engine 2 comprises, from upstream to downstream, a fan 20, a compressor section 22, comprising a low-pressure compressor 220 and a high-pressure compressor 222, a combustion chamber 24 and a turbine section 26, comprising a high-pressure turbine 262 and a low-pressure turbine 260.

The compressor section 22 comprises a series of stages, each comprising a rotor blade wheel (rotor) rotating in front of a stator blade wheel (stator). The turbine section 26 also comprises a series of stages, each comprising a stator blade wheel (stator) behind which a rotor blade wheel (rotor) rotates.

The fan 20, the rotor part of the low-pressure compressor 220, and the rotor part of the low-pressure turbine 260 are connected by a low-pressure shaft 280 extending along the longitudinal axis X-X, thus forming a low-pressure body 20, 220, 260, 280. The rotor part of the high-pressure compressor 222 and the rotor part of the high-pressure turbine 262 are connected by a high-pressure shaft 282 extending along the longitudinal axis X-X, thus forming a high-pressure body 222, 262, 282. The low-pressure shaft 280 is generally housed, along a portion of its length, within the high-pressure shaft 282 and is coaxial with the high-pressure shaft 282.

The compressor section 22, the combustion chamber 24, and the turbine section 26 are enclosed by an engine casing 23, to which are connected the stator parts of the low-pressure compressor 220, the high-pressure compressor 222, the high-pressure turbine 262, and the low-pressure turbine 260, while the fan 20 is enclosed by a fan casing 25. The engine casing 23 and the fan casing 25 are connected to each other by profiled arms 27 forming guide vanes or OGVs (Outlet Guide Vanes) distributed circumferentially around the longitudinal axis X-X. At least some of these arms 27 may be structural. The longitudinal axis X-X defines the axis of rotation for the fan 20, the rotor parts of the compressor section 22 and the rotor parts of the turbine section 26, in other words for the low-pressure body 20, 220, 260, 280 and the high-pressure body 222, 262, 282, which are each capable of being rotated around the longitudinal axis X-X relative to the engine casing 23 and the fan casing 25.

The nacelle 3 extends radially outside the engine 2, all around the longitudinal axis X-X, so as to surround both the fan casing 25 and the engine casing 23, and to define, with a downstream part of the engine casing 23, a downstream part of a secondary flow path B, the upstream part of the secondary flow path B being defined by the fan casing 25 and an upstream part of the engine casing 23. The upstream part of the nacelle 3 further defines an air inlet 29 through which the fan 20 draws in the airflow circulating through the propulsion unit 1. The nacelle 3 is integral with the fan casing 25 and attached to the aircraft 100 by means of the mast.

The engine 2 may also comprise at least one accessory gear box, called AGB (for “Accessory gear box”), for example housed in a cavity formed within the nacelle 3. The accessory gear box comprises a set of rotating elements, such as gears, enabling a plurality of shafts to be rotated around their own axis, accessories being mounted on these shafts to derive useful mechanical power from their rotation. The gear set is in turn driven by means of a power take-off shaft (or RDS for “Radial Drive Shaft”) connecting, possibly via a transfer case, the accessory gear box to at least one of the high-pressure body 222, 262, 282 and the low-pressure body 20, 220, 260, 280, typically by being meshed with at least one of the high-pressure shaft 282 and the low-pressure shaft 280. In this respect, the power take-off shaft may extend inside a longitudinal cavity formed within one of the arms 27. In this way, mechanical power is likely to be taken from at least one of the high-pressure body 222, 262, 282 and the low-pressure body 20, 220, 260, 280 to be delivered to at least one of the accessories via the accessory gear box.

The combustion chamber 24 comprises a fuel injection rail and a plurality of ignition injectors. The injection rail and/or the ignition injectors constitute fuel-consuming members of the engine 2.

The engine 2 further comprises a number of members (or equipment) configured to be actuated by means of fuel. More specifically, these members are hydraulically actuated and are designed to use pressurized fuel to power them. These members are usually referred to as “variable geometry equipment (or accessories)” or, more simply, “variable geometry” equipment. Examples of variable geometries include variable-pitch vanes (for example, stator vanes of a high-pressure compressor 222), and discharge valves of the primary flow path A or of the secondary flow path B. These variable geometries require hydraulic energy linked to fuel pressure to operate. However, unlike a combustion chamber (ignition or fuel rail) injector, variable geometries do not consume fuel because they do not degrade it through combustion.

A controller can also be used to interface between the engine 2 and the aircraft 100, and to control the engine 2. Typically, the controller can perform the following functions: controlling the circulation of various fluids necessary for the operation of the engine 2, starting the engine 2, transmitting various parameters measured from the engine 2 to the cockpit of the aircraft 100, managing thrust or reverse thrust, etc. Such a controller can implement digital control and comprise a computer, memory, and various data exchange channels that interact with each other. Typically, the controller can be of the FADEC (for “Full Authority Digital Engine Control”) type.

During operation, the fan 20 draws in an airflow, a portion of which, circulating within a primary flow path A that passes completely through the engine casing 23, is successively compressed within the compressor section 22, ignited within the combustion chamber 24 by fuel combustion, and expanded within the turbine section 26 before being ejected from the engine 2. Another portion of the airflow circulates within the secondary flow path B, which takes an elongated annular form surrounding the engine casing 23, the air drawn in by the fan 20 is straightened by the straighteners 27 then ejected from the propulsion unit 1. In this way, the propulsion unit 1 generates thrust. This thrust can, for example, be used to power the aircraft 100 on which the propulsion unit 1 is mounted.

### Fuel Control System

In order to manage the supply of fuel-consuming members, such as the (ignition or fuel rail) injectors of the combustion chamber 24, and the variable geometries, the engine 2 comprises a fuel control system 4.

The fuel control system 4 comprises a fuel source 40, such as a fuel storage tank or a fuel supply circuit, intended to supply fuel for combustion within the combustion chamber 24 and, optionally, for actuation of variable geometries. Furthermore, a supply conduit 400 is connected to the fuel source 40.

The fuel control system 4 comprises a main circuit 41 connected to the fuel source 40 via the supply conduit 400, a recirculation circuit 42, connected to the main circuit 41, and a control device 43.

Advantageously, a centrifugal feed pump 4000, called a low-pressure pump, is interposed between the fuel source 40 and the main circuit 41, on the supply conduit 400, for pressurizing the main circuit 41.

The main circuit 41 comprises an additional pump 411 intended to ensure, at least in part, or even entirely, the supply of fuel to the combustion chamber 24, and/or the variable geometries, at the pressure and/or flowrate required by their operation.

The pump 411 comprises an inlet port 4111 and a discharge port 4112. The pump 411 is arranged so that its inlet port 4111 is connected to the supply conduit 400 to admit fuel from the fuel source 40, optionally pre-pressurized by the centrifugal feed pump 4000. The inlet port 4111 of the pump 411 is connected to the supply conduit 400 by a main conduit 410. The pump 411 also comprises a stator part and a rotor part, the rotor part being designed to be driven relative to the stator part at a certain drive speed.

The drive of the pump 411 can be implemented by mechanical power extraction from one of the low-pressure bodies 20, 220, 260, 280 and the high-pressure bodies 222, 262, 282, optionally via the accessory gear box. In this case, the drive speed of the pump 411 is directly related to the engine speed 2.

Alternatively, a mechanical differential can be interposed between the accessory gear box and the pump 411, to decouple the drive speed of the pump 411 from the speed of the engine 2. In this case, an external motor/generator, which is electric or otherwise, is also connected to the differential, to allow modulation of the drive speed of the pump 411.

Alternatively, the drive of the pump 411 is not implemented by mechanical power extraction on one of the low-pressure body 20, 220, 260, 280 and the high-pressure body 222, 262, 282, but is implemented by means of an electric drive motor, the speed of which can be controlled.

In any case, decoupling the drive speed of the pump 411 from the engine speed 2 allows the fuel flowrate discharged by pump 411 to be modulated independently of the engine speed 2. In this respect, the fuel control system 4 may comprise a device 4114 for controlling the drive speed of the pump 411, which drives the differential or the electric drive motor, as appropriate.

The pump 411 is preferably a positive displacement pump. The pump 411 may further have variable displacement. In this respect, the fuel control system 4 may comprise a control member 4113 which allows the displacement of the pump 411 to be adjusted and, thus, the fuel flowrate discharged by the pump 411 to be modulated independently of the drive speed of the pump 411.

The main circuit 41 further comprises a discharge conduit 412 connected to the discharge port 4112 of the pump 411 and to a fuel-consuming element, such as a combustion chamber injector 24, so that the latter receives fuel from the pump 411. Thus, at least part of the fuel discharged by the pump 411 can be admitted into the combustion chamber 24 to be mixed with the air from the compressor section 22 in order to be ignited.

Advantageously, the main circuit 41 comprises a regulator 417 positioned on the discharge conduit 412. The regulator 417 operates on the same principle as a hydromechanical unit and comprises a flow meter. The regulator 417 is advantageously connected to the control device 4114 and/or the control member 4113 to control the fuel flowrate discharged by the pump 411 according to the specific requirements of the combustion chamber 24.

Advantageously, the main circuit 41 further comprises a filter 415 positioned on the main conduit 410, between the fuel source 40 and the inlet port 4110 of the pump 411. The filter 415 allows the fuel circulating within the fuel control system 4 to be treated in order to optimize its operation.

### Heat Exchanger

The main circuit 41 further comprises a heat exchanger 413 positioned on the main conduit 410, between the fuel source 40 and the inlet port 4110 of the pump 411. The heat exchanger 413 cools a heat transfer fluid using the fuel. The fuel control system 4 is then considered a cold source capable of absorbing heat from the heat transfer fluid.

The heat exchanger 413 comprises a primary circuit 4131 and a secondary circuit 4132. The primary circuit 4131 of the heat exchanger 413 has an inlet 4133 connected to the fuel source 40 and an outlet 4134 connected to the inlet port 4110 of the pump 411, via the main conduit 410.

The secondary circuit 4132 of the heat exchanger 413 is connected to a heat transfer fluid circuit 210 of the engine 2. The heat transfer fluid can be any fluid circulating in the engine 2 to cool or lubricate certain parts of the engine 2, such as lubricating oil or a cooling fluid, such as for example an electric machine cooling fluid.

The heat exchanger 413 thus ensures a heat transfer between fuel circulating in the primary circuit 4131 of the heat exchanger 413 and heat transfer fluid circulating in the secondary circuit 4132 of the heat exchanger 413.

Thus, such a fuel control system 4 allows, among others, for more efficient cooling of the heat transfer fluid. Indeed, by positioning the heat exchanger 413 upstream of the pump 411, the fuel circulating within the primary circuit 4131 is cooler. The heat transfer between the fuel and the heat transfer fluid is therefore improved.

Advantageously, the main circuit 41 comprises an additional heat exchanger 414. The additional heat exchanger 414 performs the same function of cooling a heat transfer fluid with fuel as the heat exchanger 413. The additional heat exchanger 414 comprises a primary circuit 4141 and a secondary circuit 4142. The primary circuit 4141 of the additional heat exchanger 414 has an inlet 4143 and an outlet 4144.

According to one embodiment, the additional heat exchanger 414 is positioned upstream of the pump 411, in the direction of fuel circulation within the fuel control system 4 when the pump 411 is operating. In other words, the additional heat exchanger 414 is positioned on the main conduit 410, between the fuel source 40 and the inlet port 4110 of the pump 411. The additional heat exchanger 414 can then be arranged in parallel or in series with the heat exchanger 413, upstream or downstream of the heat exchanger 413. Thus, the inlet 4143 of the primary circuit 4141 of the additional heat exchanger 414 is connected either to the fuel source 40 or to the outlet 4134 of the primary circuit 4131 of the heat exchanger 413. And, the outlet 4144 of the primary circuit 4141 of the additional heat exchanger 414 is connected either to the inlet 4133 of the primary circuit 4131 of the heat exchanger 413 or to the inlet port 4111 of the pump 411.

According to another embodiment, the additional heat exchanger 414 is positioned downstream of the pump 411, in the direction of fuel circulation within the fuel control system 4 when the pump 411 is operating, being arranged on the discharge conduit 412. In this respect, the inlet 4143 of the primary circuit 4141 of the additional heat exchanger 414 is connected to the discharge port 4112 of the pump 411, and the outlet 4144 of the primary circuit 4141 of the additional heat exchanger 414 is connected to a fuel-consuming member, such as the combustion chamber 24 and/or a variable geometry.

The secondary circuit 4142 of the additional heat exchanger 414 is connected to a heat transfer fluid circuit 220 which is separate from the heat transfer fluid circuit to which the secondary circuit 4132 of the heat exchanger 413 is connected.

The main circuit 41 may comprise several additional heat exchangers 414 positioned on the main conduit 410, between the fuel source 40 and the inlet port 4110 of the pump 411 and/or on the discharge conduit 412, between the discharge port 4112 of the pump 411 and a fuel-consuming member.

According to one embodiment, the secondary circuit 4132 of the heat exchanger 413 is connected to a lubricating oil circuit and the secondary circuit 4142 of the additional heat exchanger 414 is connected to a cooling fluid circuit for an electric machine.

According to another embodiment, the secondary circuit 4132 of the heat exchanger 413 is connected to a cooling fluid circuit for an electric machine and the secondary circuit 4142 of the additional heat exchanger 414 is connected to a lubricating oil circuit.

The filter 415 can be positioned on the main conduit 410 upstream of the heat exchanger 413 and the additional heat exchanger 414.

Advantageously, the main circuit 41 further comprises a restriction 416 arranged at the discharge conduit 412 and configured to control the fuel flowrate discharged by the pump 411. More specifically, the restriction 416 is configured to generate pressure losses (or pressure drops), of a thermal nature, within the discharge conduit 412, thereby adjusting the fuel flowrate within the conduit connecting the discharge conduit 412 to the injectors of the combustion chamber 24. The restriction 416 may be a variable-area valve controlled by a servo-valve.

### Recirculation Circuit

The fuel control system 4 further comprises a recirculation circuit 42. The recirculation circuit 42 comprises a secondary conduit 421 and a bypass-valve 422. The recirculation circuit 42 is arranged to draw from the discharge conduit 412, by means of the secondary conduit 421, fuel discharged through the discharge port 4112 of the pump 411 and reinject this drawn fuel into the primary circuit 4131 of the heat exchanger 413 and/or within the primary circuit 4141 of the additional heat exchanger 414.

The bypass-valve 422 is mounted on the secondary conduit 421 of the recirculation circuit 42. The bypass-valve 422 is configured to control the flowrate of fuel circulating through the secondary conduit 421 into the primary circuit 4131 of the heat exchanger 413 and/or right into the primary circuit 4141 of the additional heat exchanger 414.

The bypass-valve 422 is controlled by the control device 43.

The bypass-valve 422 is further configured to control the flowrate of fuel discharged through the discharge port 4112 of the pump 411 in the event of a failure of the control member 4113 and/or the control device 4114. The recirculation circuit 42 then acts as an overflow for the discharge conduit 412 to prevent an excessive flowrate of fuel from feeding the combustion chamber 24.

The bypass-valve 422 therefore preferably has a dual function. On the one hand, it allows modulation of the flowrate of fuel circulating within the primary circuit 4131, 4141, of the heat exchanger 413, and/or the additional heat exchanger 414. On the other hand, it preferably allows control of the flowrate of fuel circulating within the discharge conduit 412 and sent to the combustion chamber 24, in the event of failure of the control member 4113 and/or the control device 4114.

Thus, such a fuel control system 4 allows for more efficient cooling of the heat transfer fluid. Indeed, the recirculation circuit 42 increases the fuel flowrate within the primary circuit 4131, 4141, of the heat exchanger 413, and/or the additional heat exchanger 414. Such an increase therefore improves the heat transfer between the fuel and the heat transfer fluid.

### Control Device

The control device 43 is configured to control the bypass-valve 422 based on a temperature of the heat transfer fluid circulating in the secondary circuit 4132, 4142, of the heat exchanger 413 and/or the additional heat exchanger 414, of a fuel flowrate at the inlet 4133, 4143, of the primary circuit 4131, 4141, of the heat exchanger 413 and/or the additional heat exchanger 414, and/or a pressure difference across the terminals of the bypass-valve 422.

Advantageously, the control device 43 can also be configured to control the bypass-valve 422 based on the flowrate of fuel circulating within the discharge conduit 412 and sent to the combustion chamber 24, in the event of failure of the control member 4113 and/or the control device 4114.

Thus, the presence of the bypass-valve 422 in the recirculation circuit 42 allows the flowrate of fuel circulating within the primary circuit 4131, 4141, the heat exchanger 413, and/or the additional heat exchanger 414 to be modulated depending on the thermal cooling requirements of the heat transfer fluid and no longer only depending on the fuel supply requirements of the combustion chamber 24. Moreover, the control of the bypass-valve 422 depending on the flowrate of fuel circulating within the discharge conduit 412 allows to compensate for a failure of the control member and/or the control device 4114 and thus avoid an excessive transmission of fuel to the combustion chamber 24.

### Fuel Control Method

A fuel control method can be implemented, in particular through a fuel control system 4.

The method first involves a drawing E1 of part of the fuel, which is discharged through the discharge port 4112 of the pump 411, via the recirculation circuit 42.

The recirculation circuit 42 performs, by means of the secondary conduit 421, an injection E2 within the primary circuit 4131, 4141, of the heat exchanger 413 and/or the additional heat exchanger 414 of the fuel previously drawn.

The bypass-valve 422 implements a modulation E3 of the fuel flowrate injected within the primary circuit 4131, 4141 of the heat exchanger 413 and/or the additional heat exchanger 414, so as to increase the heat transfer between, on the one hand, the fuel circulating in the primary circuit 4131, 4141 of the heat exchanger 413 and/or the additional heat exchanger 414 and, on the other hand, the heat transfer fluid circulating in the secondary circuit 4132, 4142 of the heat exchanger 413 and/or the additional heat exchanger 414.

Moreover, the bypass-valve 422 can implement a step of controlling E4 the flowrate of fuel circulating within the discharge conduit 414 and sent to the combustion chamber 24, particularly in the event of failure of the control member 4113 and/or the control device 4114.

1. A fuel control system comprising:
a pump comprising an inlet port and a discharge port, the inlet port being intended to be connected to a fuel source, the discharge port being configured to be connected to a combustion chamber of an aircraft engine to supply the combustion chamber with fuel;
a heat exchanger comprising a primary circuit and a secondary circuit the primary circuit of the heat exchanger having an inlet configured to be connected to the fuel source and an outlet connected to the inlet port of the pump, the secondary circuit of the heat exchanger being intended to be connected to a heat transfer fluid circuit of the aircraft engine, the heat exchanger being configured to provide heat transfer between fuel circulating in the primary circuit of the heat exchanger and heat transfer fluid circulating in the secondary circuit of the heat exchanger
a recirculation circuit arranged to draw fuel discharged through the discharge port of the pump and reinject the drawn fuel into the primary circuit of the heat exchanger, the recirculation circuit comprising a bypass-valve configured to modulate the flowrate of fuel circulating within the recirculation circuit and
a control device configured to control the bypass-valve based on a temperature of the heat transfer fluid circulating in the secondary circuit of the heat exchanger and/or a fuel flowrate at the inlet of the primary circuit of the heat exchanger, so as to increase the heat transfer between the fuel circulating in the primary circuit of the heat exchanger and the heat transfer fluid circulating in the secondary circuit of the heat exchanger.

2. The fuel control system of claim 1, wherein the control device is configured to control the bypass-valve based on a pressure difference across the terminals of the bypass-valve.

3. The fuel control system of claim 1, wherein the pump is of a volumetric type.

4. The fuel control system of claim 3, wherein the pump has a variable displacement, the fuel control system further comprising a member for controlling the displacement of the pump and/or a device for controlling a drive speed of the pump.

5. The fuel control system of claim 4, wherein the bypass-valve is further configured to increase the flowrate of fuel circulating within the recirculation circuit in the event of failure of the control member and/or the control device.

6. The fuel control system of claim 1, further comprising an additional heat exchanger comprising a primary circuit and a secondary circuit, the secondary circuit of the additional heat exchanger being intended to be connected to an additional circuit of another heat transfer fluid of the aircraft engine, the additional heat exchanger being configured to provide heat transfer between fuel circulating in the primary circuit of the additional heat exchanger and the other heat transfer fluid circulating in the secondary circuit of the additional heat exchanger.

7. An aircraft engine comprising:
the fuel control system of claim 1;
a heat transfer fluid circuit connected to the secondary circuit of the heat exchanger of the fuel control system.

8. The aircraft engine of claim 7,
wherein the fuel control system further comprising an additional heat exchanger comprising a primary circuit and a secondary circuit, the secondary circuit of the additional heat exchanger being intended to be connected to an additional circuit of another heat transfer fluid of the aircraft engine, the additional heat exchanger being configured to provide heat transfer between fuel circulating in the primary circuit of the additional heat exchanger and the other heat transfer fluid circulating in the secondary circuit of the additional heat exchanger, wherein the aircraft engine comprises an additional circuit of another heat transfer fluid connected to the secondary circuit of the additional heat exchanger of the fuel control system.

9. An aircraft comprising an airframe and the aircraft engine of claim 7, wherein the aircraft engine is fixed to the airframe.

10. A method comprising:
withdrawing a part of fuel discharged through a discharge port of a pump of a fuel control system of an aircraft engine the discharge port being connected to a combustion chamber of the aircraft engine to supply it with fuel;
injecting the withdrawn fuel into a primary circuit of a heat exchanger of the fuel control system the heat exchanger comprising the primary circuit and a secondary circuit, the primary circuit of the heat exchanger having an inlet connected to a fuel source of the fuel control system and an outlet connected to an inlet port of the pump, the secondary circuit of the heat exchanger being connected to a heat transfer fluid circuit of the aircraft engine the heat exchanger being configured to provide heat transfer between fuel circulating in the primary circuit of the heat exchanger and heat transfer fluid circulating in the secondary circuit of the heat exchanger and
modulating the fuel flowrate injected into the primary circuit of the heat exchanger so as to increase the heat transfer between the fuel circulating in the primary circuit of the heat exchanger and the heat transfer fluid circulating in the secondary circuit of the heat exchanger.
